(19) United States
(12) Patent Application Publication
(10) Pub. No.: US 2006/0149470 A1
(43) Pub. Date: Jul. 6, 2006

(54) Consultation and processing system of information for hiking with the use of standard PDA hardware

(75) Inventor: Adriano Scardellato, Treviso (IT)

Correspondence Address: John S. Egbert;Egbert Law Offices, 7th Floor, 412 Main Street, Houston, TX, 77002, US

(73) Assignee: GIOVE S.r.l., Treviso (IT)

(21) Appl. No.: 11/290,922

(22) Filed: Nov. 30, 2005

(30) Foreign Application Priority Data
Dec. 30, 2004 (IT) TV2004A000159

(51) Int. Cl. G01C 21/36; G01C 21/28

(52) U.S. Cl. 701/213; 701/200

(57) ABSTRACT

A system for the consultation and processing of information for hiking with the use of standard hardware of the PDA type or an equivalent integrates or cooperates with the following functions: compass, altimeter, and coordinates. It provides the following mode of use: consultation with GPS off by cartography consultation without GPS positioning with the possibility of selection and inquiry of the database; creation of itineraries and calculation of the path; free navigation by cartography consultation with GPS positioning; and guided navigation by a cartographic guide, written and vocal on a pre-set itinerary/path. The product is installed completely, and on its start the user can decide which mode to use. The applications are based on the same motor, present common functions and functions specific to the mode used. The interface has the same graphic style but is functionally different.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The object of this invention is a system with consultation and processing functions of information for hiking and the use of standard hardware of the PDA type or equivalent. The invention finds particular but not exclusive application in the hiking sector as well as in road navigation.

### BACKGROUND OF THE INVENTION

PDAs are certainly well known. An acronym of Personal Digital Assistant, it introduces hand-held devices, electronic apparatuses by now commonly used, sometimes known as “palmtop” devices or portable organizers. This concerns apparatuses with rather contained dimensions made up of a container, generally made in plastic material, on the interior of which is found a processor and a memory with an externally integrated display, possibly an alphanumeric keypad, a seat for containing the supply part. The screens available can be in colour or tones on a grey scale. The latter are widely used for PowerPoint presentations, Web browsing, or simply to show films or images of various types.

### PRIOR ART

In CA2280677 (Gray et al.) an integrated information system is described for defining the path and the cartography that integrates a routing/mapping information system. Said information so-called IRMIS is shown as cartographic applications on the desktop of one or more hand-held devices, personal digital assistants (PDA) or palmtop devices. Said devices can optionally be equipped with, or connected to a GPS (Global Positioning System) or equivalent detection device. The desktop application facilitates the selection by the user of areas, departures, stops, destinations, maps and/or points and/or information regarding the route. It is optionally provided with online information, preferably for the transfer to the PDA or equivalent devices. The options available to the user include information on the route, area and route maps. The maps and information regarding the relative route are configured with different details and size levels.

Used in this domain, in conjunction with a GPS receiver, the PDA device is configured to represent directions, text and map formats of the current position of the user, direction, speed, elevation and so forth. Acoustic signals can identify the next turn along the planned route. The user can scan through maps and zoom between two or more map scales and size or detail levels. The IRMIS system is provided with automatic zoom, for example to show in detail when the user is close to reaching the destination, or with a larger scale and lower resolution to represent the route planned by the user between points of interest. The IRMIS system makes it possible for the user to mark or record specific places, and/or the current log of the travelling routes by using the GPS information. These places noted as “marks” and/or “breadcrumb” or log data of the GPS can be saved, updated, represented or otherwise processed on the desktop by the geographic or cartographic information system of the user. The application system can be distributed online or through tangible means, in limited and advanced manipulation formats.

DE10134116 (Willenbrock) provides a road vehicle that uses a personal digital assistant (PDA) that is coupled to a GPS and is provided with a relative data file containing the cartography. The PDA interacts with the electronics of the vehicle. The PDA can be removed from the relative support in the vehicle and placed in a base, at home or at work. The relative data can be read and transmitted to a computer to be processed.

EP0763808 (Obuchi), describes a processor that files a planned series of tours, in which a variety of means of transport are used, in a given terminal installed in a vehicle and a PDA such as a palmtop PC capable of supporting said planned series of tours. The console presents a seat for housing the PDA. The data processor of the PDA transmits to the terminal the listed tours that are extracted and referred to the vehicle. When the current position discloses the movement of the vehicle, a navigation unit guides the vehicle. At the end of the guide, the data processor installed in the vehicle activates the PDA that optimizes and releases information to the guide.

U.S. Pat. No. 6,674,445 (Chithambaram et al.) suggests a generalized coding differential, with raster indexed vector data and a scheme for maps on a PDA. A scheme provides a performance and compact file with both data and metadata for raster, vectors and information redlining. One single database is used. The vector object includes spatial indexed information, to allow spatial filtration of the objects that fall within a specific view. Therefore, the invention uses a generalized, encoded and indexed cartography to provide compactly an efficient spatial data file that communicates with the PDA that is constrained within limits defined by the file, capacity to process, memory and bandwidth.

U.S. Pat. No. 6,694,256 (Childs et al.) provides a PDA that includes a processor and a suitable memory to communicate with the processor. The memory presents cartographic data including a number of places and data indicating streets with heavy traffic of a plurality of types each connected to the sites and organized in hierarchical levels. The processor calculates a route by means of algorithms that are dynamically forced.

Some companies, particularly in the sector, have understood the need to find more effective alternative solutions with respect to the solutions in existence up to now.

The aim of this invention is also to avoid certain drawbacks.

### BRIEF SUMMARY OF THE INVENTION

This and other aims are achieved with this invention according to the characteristics as in the included claims that resolve the disclosed problems by means of a system for the consultation and processing of information for hiking with the use of standard hardware of the PDA type or an equivalent that integrates or cooperates with the following functions: compass, altimeter, coordinates (UTM 32-WGS 84). It provides the following mode of use:
Consultation (with GPS off): cartography consultation without GPS positioning with the possibility of selection and inquiry of the DB, creation of itineraries and calculation of the path;
free navigation: cartography consultation with GPS positioning; and
guided navigation: cartographic guide, written and vocal on a pre-set itinerary/path.

The product is installed completely (both applications), and on its start the user can decide which mode to use.

The applications are based on the same motor, present common functions and functions specific to the mode used. The interface has the same graphic style but is functionally different.

### AIMS

A first aim consists in producing a product for localization and for satellite navigation specifically devised for hiking.

A second aim is to provide electronic data banks created ad hoc:
1. complete information (pathways, cycle paths and mountain-bike paths, ski slopes, lifts, etc.)
2. signaling of points of interest (POI) such as refuges, ski schools, mountain first aid, hospitals, APT etc. with indication of all the useful information relating to timetables, costs, telephone numbers etc.
3. standard CAI symbols.
4. color three-dimensional morphologic representation
5. altimetric representation with depth contours

A third aim is to allow the personalization of the information: geo-referencing being possible and registration of paths, photos, notes and recall them at any moment.

A fourth aim originates from the specific calculation algorithms for the means chosen for a certain path.

A fifth aim is that of producing a single product for road navigation and for hiking, for work and for free time, on palmtop hardware that is also a practical organizer.

A sixth aim consists in finding greater simplicity and rapidity of use. In particular,
Maximum practicality in the palm of your hand thanks to the reduced dimensions and contained weight of the hardware.
Possibility of use on any palmtop or windows compatible GPS antenna.

These and other advantages will appear in the following detailed description of certain preferred embodiments.

### DETAILED DESCRIPTION OF THE INVENTION

The specifications of the applications:

| Key | |
|---|---|
| (N) | New functions with respect to competitors |
| (CS) | Existing functions in competitors but not in all. To be developed |
| (E) | Typical functions of the product |

Application called MyNAV Trek

Consultation Modality—Free/Guided navigation

Functional characteristics;
Consultation: cartography consultation without GPS positioning with the possibility of selection and inquiry of the DB, creation of itineraries and calculation of the path;
Free Navigation: cartography consultation with GPS positioning;
Guided Navigation: cartographic guide, written and vocal on an pre-set itinerary/path; and
Visualization:
   Of consultation or Navigation:
      2D;
         Raster backgrounds (morphology of the land);
         Contours;
         Altimetrical profile of the part of the path being followed; and
         Main POI, name and height of refuges and peaks;
      3D;
         Allotment of heights on links and relative altitude (to be assessed);
Instruments:
   Typical functions and instruments: (visualize localiser)
      Compass
      Altimeter
      Coordinates (wgs-utm)

### ITINERARY

Choose the paths to follow and memorize them→Mode FOLLOW (go along) the path until the following manoeuvre. The need arises from the fact that a hiker often does not calculate the path from—to but decides where he wants to pass by to arrive at a certain destination. The principle is: to follow this first path without considering possible short-cuts or alternative routes, until meeting the second path asked for, and so forth.

### PATH

Calculation of the path:
From Poi to Poi/Geo Note;
From GPS position to path name;
From GPS position to Poi/Geo Note;
From GPS position to Preferred destination;
With click on menu
With vocal recall
From GPS position to recent Destination;
Automatic recalculation (only on request) ? first warns of error and then asks if recalculation is required;
Calculation options:
   Avoid link (especially difficult paths);
   Fast;
   Short;
   Addition/Elimination of intermediate stages; (CS)
      With the possibility to change the order of the route and to add/eliminate at any time with consequent recalculation
   Choice of means: Foot/Bicycle (need/no need to consider one way systems, etc.); (CS)
      Advanced settings . . . before starting the calculation it is possible to see the choice always or only on request.
Alternative calculation on request of the user; (ski slopes)
   If the user does not like the calculated path he must have the possibility to calculate other alternatives without having to redefine any parameter.

Save the paths as favorite paths; (N)

Load the favorite paths; (N)

Recall the sequence of written instructions:
Manoeuvre icon, description, km to the manoeuvre;
Total km (progression of the manoeuvres);
Height difference;

Path summary (brief written report);

The criteria with which the path was calculated must also be shown (e.g. without motorways, avoiding city centres, etc.)

Route Guide (messaging to the user);
Language choice for manoeuvres to make (to be defined at any moment) vocal and written Italian—English—German—French—Spanish; (CS)
Function and language choice (only vocal) informing signal of the POI, in their proximity, situated along the path Italian—English—German—French—Spanish (vocal and written); (N)

### FIND/SEARCH

Search Addresses/Poi;

N.B The road is intended as the name of the typical cartographic element of the hiking DB (e.g. CAI 411)

Address:
   Municipality—Postcode—Road—Number;
   Municipality—element type; (N)
      E.g. Find the fixed-aid climbing routes present in the municipality of Cortina
   In the proximity of the position signalled by GPS and setting no. km in a range defined by the user; (CS)
   SMS type (see communication section); (CS) ? Find Friend
      The result of the search must be able to be set as Departure, Destination, Intermediate Stage, Favourite, vocal command memorization.
Poi:
   Name Poi—Municipality;
   Category—Municipality;
   In the proximity of the position signalled by GPS and setting of no. km in provincial range/area; (CS)
   Municipality—Road; (all the POI present on a road);
      The result of the research must be able to be set as Departure, Destination, Intermediate stage, Favourite, vocal command memorization.

### COMMUNICATION

Communication:
Sending of SMS with address and coordinates of the position of the GPS (Benephone type); (N)
Traffic connection; (TMC) (CS)

User interface:
Vocal. Vocal commands (input path calculation . . . ); (CS)
Sending signal (radio/gps/sms) for location for first aid; (N)
   A service centre is provided

Integration Sw third parties
Connection with the Outlook index;
Connection with received sms (only HW cellular)
Options/Settings;

Display:
day modality;
night modality;

Vocal instructions:
language change for the vocal commands;
male/female;
loudspeaker volume;
setting of vocal warnings:
low gps signal (yes/no);
absence of gps signal (yes/no);
POI arrival warning (yes/no);
reproduction GEO Notes (yes/no);

road/car parameter setting
Speed limits for:
Motorway;
Expressway;
Important thoroughfare;
By-road;
Joining road;
Important main road;
Main road;
Municipal road;
Car parameters for:
Car consumption;
Average speed;

View:
2D
Perspective view (said bird's-eye view)

Map:
Source memory (CF-SD);
Maps loaded in memory;
   The list of maps stored in the memory is shown, and I can see where they are memorized.
Visualized map;
   The map is chosen by the map the user wishes to see, the choice is exclusive.

poi to be visualized on the map:
select which you want to see;
select all;
de-select all;

Product information and DB release;

Functions set on hardware keys:
Key up;
Key down;
Key right;
Key left;

Visual navigator;
Information and controls and Automatic settings present on the display in navigator modality;
Information:
   Speed (yes/no);
   Altitude (yes/no);
   Gradient (yes/no);
   Road that is being travelled (yes/no);
   Next manoeuvre with road name (yes/no);
   Km to the next manoeuvre (yes/no);
   Km to arrival (yes/no);
   Compass (yes/no);
   No. Satellites received (yes/no);
   Total list of manoeuvres to be made (yes/no);
Commands:
   Last vocal indication (yes/no);
   Zoom +/− (yes/no);
   Pan (yes/no);
Settings:
   2D view/perspective view (said bird's-eye view) (yes/no);

navigator menu;
choice of icons/commands to be displayed in the menus
   It is necessary to understand what setting margins we want to leave to the user
Data acquisition;

Memorization of GEO NOTES in form of POI (point coordinates) on the favourites or another personal index; To the new POI I must be able to attach:
Audio/vocal file recorded outright or later;
Image file;
Text file;
   The principle is to make a “Geo Note” or tap on a point of the map and have the possibility to memorize the coordinates and combine them with an audio recording (the result is to have an Audio POI with its relative icon e.g. loudspeaker), an image or a text;

Registration of GPS tracks and saving on file *.log or .gps o.txt (encrypted);

Load file log for visualization of the tracks on the map;

Tapping Functionality (pressure with the stylus on the display) of the entity of the map;

Short Tapping both for 2D and Perspective view (said bird's-eye view)

Visualize present data elements:
Link road: name and numbers;
Other Link: (railway, river, etc.): type, name;
POI: name, road, number, telephone, external connections (description, photo, Geo Note);
Polygons: name, type (lake)

Prolonged tapping (only in 2D)

| | Cartographic Entity | | | |
|---|---|---|---|---|
| | Navigate towards; | | | |
| Function | Link | POI | Polygon | Map point |
| Departure point; | X | X | — | X |
| Insert intermediate stage; | X | X | — | X |
| Preferred destination; | X | X | — | X |
| Search neighbouring Poi; | X | X | X | X |
| Search neighbouring Roads; | X | X | X | X |
| Avoid road; | X | — | — | — |
| Avoid Area; | X | — | — | — |
| Call telephone number; | — | X | — | — |
| Memorize GEO NOTE; | X | — | X | X |

The memorize GEO NOTE must be able to be recalled easily and immediately from the display by the user

The Desktop

Functional characteristics;

Cartographic control

Processing before export to the PDA

Pre-set cut of the parts of the map to load;

Administrative cut of the maps;
Region;
Province;
Municipality

Personalized cut of the parts of the map to load
Rectangle
Polygon

Search for a municipality to visualize where it is geographically situated; The user can then decide if to export:
only the municipality
the province to which the chosen municipality belongs;
the region to which the chosen municipality belongs;
the preset portion of the software to which the chosen municipality belongs;

Choice of type of maps to export:
Cartography for vehicular navigation:
   Inter-town;
   Detail City;
   Poi;
Cartography for hiking:
   Raster backgrounds;
   Ski slopes
   Paths;
   Poi;

Consultation

Find/Search
Addresses;
Poi

Route calculation:
Possibility to calculate a path with the same modalities present in the PDA software;
Saving of path calculated;
   (see the specifications related to each application)
   Communication with PDA

Download data from PDA to PC:
Gps tracks
Geo Notes;

Load data downloaded from PDA:
Gps tracks
Geo Notes;

List/Visualization of maps already loaded on the PDA;

Export of the calculated path to the PDA;
Only instructions that the SW of the PDA reads and reproduces on the cartography;
Path comprising a cartographic buffer;

Export of the desired map to the PDA;

Installation of the SW on PDA;

I claim:

1. Information consultation and processing system for hiking with use of standard hardware of the PDA type or equivalent, comprising:
electronic data banks created ad hoc, being comprised of:
complete information (pathways, cycle paths and mountain-bike paths, ski slopes, lifts and other.)
signalling of points of interest (POI) such as refuges, ski schools, mountain first aid, hospitals, APT etc. with the indication of relative time-tables, costs, telephone numbers etc.
standard CAI symbols
colour three-dimensional morphologic representation
altimetric representation with depth contours

2. Information consultation and processing system for hiking according to claim 1, wherein the information is personalized by georeference and register paths, photos, notes recalled at any time.

3. Information consultation and processing system for hiking according to claim 1, further comprising:
calculation algorithms specific for choosing for a certain path.
